(19) United States
(12) Patent Application Publication
(10) Pub. No.: US 2010/0304975 A1
(43) Pub. Date: Dec. 2, 2010

(54) PROCESS FOR INCREASING PLANTS RESISTANCE TO AN ABIOTIC STRESS

(75) Inventors: Pascal Salvador, Grenoble (FR); Thomas Lasserre, Grenoble (FR)

Correspondence Address: YOUNG & THOMPSON, 209 Madison Street, Suite 500, Alexandria, VA, 22314, US

(73) Assignee: ELICITYL, Crolle (FR)

(21) Appl. No.: 12/675,587

(22) PCT Filed: Aug. 27, 2007
(86) PCT No.: PCT/FR2007/001403

§ 371 Date: Aug. 3, 2010

(51) Int. Cl. A01N 43/16; A01P 21/00

(52) U.S. Cl. 504/292

(57) ABSTRACT

A process for adapting plants to an abiotic stress, in particular to cold or to a hydric stress, in particular drought, humidity or salinity, wherein the process includes at least a step of treatment of the plants by foliar field spraying with a composition including at least one xyloglucan derivative in particular conditions of application.

A subject of the present invention is a process for increasing plants resistance to abiotic stress, in particular cold, or to hydric stress by foliar spraying of a composition based on xyloglucans.

The cell walls of fruits and vegetables are formed by polysaccharides, mainly pectin, cellulose and xyloglucan which are involved in putting the walls in place (Levy S et al., Plant J. 1997, 11(3): 373-86). Xyloglucan is also found in large quantities in the endosperm of the seeds of Dicotyledons.

Xyloglucan is a 1,4-β-glucan polymer substituted differently according to its origin. In the Dicotyledons, the substitutions of the linear 1,4 β-D-glucan chains most often involve 1,6 α-D-xylosyl-, or 1,6 α-D-xylose 1,2 β-D-galactosyl-type branchings, and fucose can be associated, at the terminal position, with galactose, i.e. a 1,6 α-D-xylose 1,2 β-D-galactose 1,2 α-L-fucosyl-type side branching. In the Dicotyledons, the fucose residue is always absent from the endosperm, and it can be replaced by the -L-arabinose residue, for example in certain Solanaceae. The xyloglucan of Monocotyledons differs from that of Dicotyledons by a lower rate of substitution by xylose and galactose residues and by the absence of fucose. The xyloglucan forms, with the cellulose microfibres, bridged structures which constitute the structure and ensure the flexibility of the cell wall of plants (Pauly M, Albersheim P, Darvill A, York WS (1999) Plant J, 20 (6): 629-39).

Xyloglucan is a substrate of endoxyloglucanases (Vincken J P, Beldman G, Voragen A G Carbohydr Res (1997) 13, 298(4):299-310) or of xyloglucan endotransglycosylase (Steele N M, Fry S C, Biochem J (1999) 15, 340, 1, 207-211), namely of enzymatic activities capable of modifying the structure of the cell walls during cell elongation, in the germination and fructification periods for example and which are dependent on hormones, in particular auxins (Hetherington P R and Fry S. (1993) Plant Physiology, 103, 987-992), and gibberellins (Maclachlan G and Brady C (1994) Plant Physiol 105, 965-974).

Xyloglucan, in particular a fucosylated oligomer, the nonasaccharide XXFG (described in Fry et al. (1993) Physiologia Plantarum, 89, 1-3), is well known for its anti-auxinic effect (McDougall C J and Fry S C (1989) Plant Physiol 89, 883-887). Conversely, oligomers without fucose but with galactose such as the oligomers XXLG and XLLG have an auxinic effect (McDougall G J and Fry S C (1990) Plant Physiology 93, 1042-1048).

Moreover, a number of signals generate activated oxygen species (also referred to as “oxidative burst”). Active oxygen species are well known for being released during plant-pathogen interactions. Oligosaccharides of various origin (polygalacturonic acid, chitosan, O-glycans etc.) have been recorded for their ability to generate an oxidative burst (Low P S and Heinstein P F (1986) Arch. Biochem. Biophys. 249, 472-479; Rogers K R., Albert F, and Anderson A J (1988) Plant Physiol 86, 547-553; Apostol I, Heinstein P F and Low P S (1989) Plant Physiol 90, 109-116; Vera-Estrella R, Blumwald E and Higgins V J (1992) Plant Physiol. 1208-1215; Bolwell G P, Butt V S, Davies D R and Zimmerlin A. (1995) Free Rad. Res. Comm 23, 517-532; Orozco-Cardenas M and Ryan C A (1999) PNAS, 25, 96, 11, 6553-655; Nita-Lazar M, Iwahara S, Takegawa K, Lienart Y (2000) J Plant Physiol, 156, 306-311). Oxidoreductase NAD(P)H enzymes for the release of superoxide anion (Van Gestelen P V, Asard A, Caubergs R J (1997)

Plant Physiol 115, 543-550) and peroxidases for the formation of peroxide or of superoxide anion or of OH radicals are involved (Baker C J and Orlandi E W (1995) Ann Rev. Phytopathol, 33, 299-321; Chen S X and Schopfer P (1999) Eur Bioch 260, 726-735). Other signals (salicylic acid, jasmonates, cGMP, NO etc.) also generate a burst (Chen Z, Malamy J, Henning J, Conrath U, Sanchez-Casas P, Silva H, Ricigliano J, Klessig D F (1995) Proc Natl Acad Sci USA, 92, 4134-4137; Voros K, Feussner I, Kuhn H, Lee J, Graner A, Lobler M, Parthier B, Wasternack C Eur J Biochem (1998) 15, 251, 36-44; Durner J, and Klessig J, Wendehenne D, Klessig D F (1998) Proc Natl Acad Sci USA, 95, 10328-10333; Durner D and Klessig D F (1999) Current Opinion in Plant Biology, 2, 369-374).

Extreme environmental conditions (drought, cold, UV, salinity etc.) trigger the same effect (Suzuki N, Mittler R (2006) Physiol. Plant. 126, 45-51; Wang, W., Vinocur, B., Altman, A. (2003) Planta 218 1-14; Palva, E. T., Htiharju, S. T., Tamminen, I., Puhakainen, T., Laitinen, R. Savensson, J., Helenius, E., and Heino, P. (2002) JIRCAS working report 9-15).

The major role of H₂O₂ in the generation of the burst as in the regulation of oxidative stress is based on:
its formation by dismutation from the superoxide anion (Bolwell G P, Davies D R, Gerrish C, Auh C K and Murphy T M (1998) Plant Physiol 116, 1379-1385),
its use in C₁₈ fatty acid metabolism sequences (for the peroxidation of lipids (Koch E, Meier B M, Eiben H-G, Slusarenko A (1992) Plant Physiol 99, 571-576) or for the synthesis of octadecanoids and of their derivatives, certain of which such as the methyl-jasmonates are metabolites with a hormonal function,
its function as substrate for the peroxidase and catalase enzymes, property of limiting the accumulation of toxic peroxide for the cell (Baker C J, Harmon G L, Glazener J A and Orlandi E W (1995) Plant Physiol, 108, 353-359).

The active oxygen species, the superoxide anion in particular, control different metabolic pathways. They are involved in:
the biosynthesis of polyamines: monoamines are oxidized to aldehydes with the production of NH₃ and peroxide. The oxidation of L-arginine by nitrite synthase results in the formation of a polyamine precursor (L-citrulline),
the synthesis of ethylene,
the synthesis of gibberellins. More than 20 oxidases are involved in the regulation of the biosynthesis of gibberellins

The active oxygen species are involved in signal transduction stages, because they are associated with receptor bond activity or transduction enzyme activity (Jabs T, Tschöpe M, Colling C, Hahlbrock K and Scheel D (1997) Proc Natl Acad Sci USA 29, 94, 9, 4800-4805; Durner J, Wendehenne D, Klessig D F (1998) Proc Natl Acad Sci USA, 95, 10328-10333).

They are involved in the regulation of the cell redox potential using thiol groups (GSSG-GSH, cystine-cysteine conversion, etc.). In this way, they control senescence processes which are manifested during certain flowering and fructification phases in different organs.

The oxidative burst interferes with the hormonal metabolism, the most efficient potential for regulating the flowering and fructification stages (in particular their triggering and their duration are programmed by a hormonal balance (auxin/cytokinin ratio for example), and the active oxygen species, including peroxide, control the synthesis of polyamines).

In the applications WO 02/26037 and WO 03/079785 the Inventors described that xyloglucan polymers and oligomers, in particular compounds comprising an osidic structure of formula XFG, as well as compounds derived from the latter, have a stimulating effect on the glutathione reductase enzyme, the phospholipase D enzyme in plants, as well as the glycosylhydrolases.

By stimulating the glutathione reductase enzyme, the compounds of the invention trigger the reactions of adaptation to any oxidant stress, such as cold in particular, by limiting the toxic effects of the active oxygen species (Allen R D, Webb R P, Schake ITS (1997) Free Radic Biol Med, 23 (3):473-479; O'Kane D, Gill V, Boyd P, Burdon R (1996) Planta, 198 (3):371-377), and they regulate the redox potential of the cell, which modifies the activity of enzymes or thiol-dependent proteins, phospholipase D, thiol-proteases and inhibitors of thiol-proteases in particular (Taher M M, Mahgoub M A, Abd-Elfattah (1998) AS Biochem Mol Biol Int 46 3, 619-28), as well as by a thiol-dependent protease inhibitor induction effect, and without however activating a cascade of other enzymatic systems in proportions harmful to the plant.

By stimulating the phospholipase D activity, these compounds amplify the hormonal effect of abscisic acid to the extent that the activation of the enzyme leads to the production of phosphatidic acid (which mimics the effects of abscisic acid). In this way, they can reveal an antagonism against the gibberellins, ethylene or jasmonates (Grill E., Himmelbach A. (1998) Current Opinion in Plant Biology, 1, 1, 5, 412-418; Ritchie S, Gilroy S (1998) Plant Biology, 95, 5, 3, 2697-2702; Moons A, Prinsen E, Bauw G, Van Montagu M (1997) Plant Cell 9 12, 2243-59). These compounds have been found to be particularly useful in the phytosanitary and biofertilization field, in particular as elicitors, and more particularly to combat abiotic stress in plants, and control flowering and fructification.

In the pursuit of their work, the inventors have demonstrated that said compounds may be utilised in particular conditions.

Thus one of the purposes of the present invention is to provide a process for adapting plants to an abiotic stress, in particular to cold or to a hydric stress, in particular drought, humidity or salinity, wherein said process comprises at least a step of treatment of the plants by foliar field spraying with a composition comprising at least one xyloglucan derivative at a concentration of 0.01 mg to 2 g /ha of said xyloglucan derivative, advantageously from 0.1 mg to 0.5 g/ha, said spraying step being realized between 1 and 72 hours before the stress arrived, advantageously between 5 and 48 hours before said stress.

In an advantageous embodiment of the invention, the at least one xyloglucan derivative corresponds to the formula:

[X1—X2—X3—(X4)n]N

in which
X1, X2, X3, and X4, independently of each other, represent a monosaccharide chosen from glucose, galactose, xylose, fucose and arabinose, this monosaccharide being if appropriate in reduced form and/or being substituted, in particular by a C₁-C₄ alkyl or acyl group, such as a methyl or acetyl group, X1, X2, X3, and X4, independently of each other, being if appropriate substituted by one or more monosaccharides chosen from glucose, galactose, xylose, fucose and arabinose, and/or by one or more monosaccharide chain formations of formula X5—X6—(X7)m, in which X5, X6, and X7, independently of each other, represent a monosaccharide chosen from glucose, galactose, xylose, fucose and arabinose, and m represents 0 or 1, or a compound derived from those defined above, in particular by modification or substitution of one or more abovementioned monosaccharides,
n represents 0 or 1 and
N represents an integer comprised between approximately 50 and approximately 300, advantageously comprised between approximately 50 and approximately 100, in the case of polymers and represents an integer comprised between approximately 1 and approximately 50, advantageously comprised between approximately 2 and approximately 50, even more advantageously comprised between approximately 2 and approximately 20, in particular between 5 and 12, in the case of oligomers.

Even more advantageously, the at least one xyloglucan polymer is a compound A which comprises:
one or two X chain formations, X being chosen from the group constituted by the following chain formations:
   α-D-Xylopyranosyl(1, 6)-β-D-Glucopyranosyl,
   α-D-Xylopyranosyl(1,6)-D-Glucopyranose,
   β-D-Xylopyranosyl(1,4)-(β-D-Glucopyranosyl and
   β-D-Xylopyranosyl (1,4)-D-Glucopyranose, or a reduced form of X, also denoted Xol,
one or two F chain formations, F being chosen from the group constituted by the following chain formations:
   α-L-Fucopyranosyl(1,2)β-D-Galactopyranosyl,
   (1,2)-α-D-Xylopyranosyl(1,6)-β-D-Glucopyranosyl,
   α-L-Fucopyranosyl(1,2)-β-D-Galactopyranosyl,
   (1,2)-α-D-Xylopyranosyl(1,6)-D-Glucopyranose,
   α-L-Fucopyranosyl(1,2)-β-D-Galactopyranosyl(1,2)-β-D-Xylopyranosyl(1,4)-β-D-Glucopyranosyl and
   α-L-Fucopyranosyl(1,2)-β-D-(1,2)-β-D-Xylopyranosyl(1,4)-D-Glucopyranose,
      or a reduced form of F, also denoted Fol, and
at least one G chain formation, G being chosen from the group constituted by the following units:
   β-D-glucopyranosyl and
   D-Glucopyranose,
      said units being optionally substituted in position 4, or a reduced form of G, also denoted Gol,
      said X, F and G chain formations being linked to each other in a random order, and comprising, if appropriate, the following modifications: (i) by modification of hydroxyl groups, namely acetylated or methoxylated or acylated derivatives, the glucose residue in the terminal position of which is reduced or not, (ii) by modification of the reducing terminal unit, such as by reductive amination, (iii) by oxidation, in position 6 of the accessible Gal and Glc residues.

In the context of the present invention, the following abbreviations are used: Fuc for fucose, Gal for Galactose, Glu for glucose, Xyl for xylose, Xol, Fol and Gol respectively for the reduced forms of X, F and G and correspond to those used by Fry et al. (1993) Physiologia Plantarum, 89, 1-3.

Advantageously the compounds A are chosen from the group comprising the following formulae:

(X)ₐ(F)_{b}(G)_{c}

(X)ₐ(G)_{c}(F)_{b}

(F)_{b}(X)ₐ(G)_{c}

(F)_{b}(G)_{c}(X)ₐ

(G)_{c}(X)ₐ(F)_{b}

(G)_{c}(X)ₐ(F)_{b}

in which:
G, X and F are as defined previously and a, b, and c, independently of each other represent 1, or 2.

Even more advantageously, in the eliciting compositions according to the invention, the compound A is chosen from the group comprising XFG, FXG, FGX, GFX, and GXF, the glucose residue in the terminal position of which is reduced or not, or comprising structures derived by modification as defined previously or from the group comprising: XGXG, XFGX, FGXX, FXGX, FXXG, GXXF, GXFX, GFXX, XXGF, XGXF, XGFX and XXFG.

Among the compounds XFG or its derivatives there may in particular be mentioned:

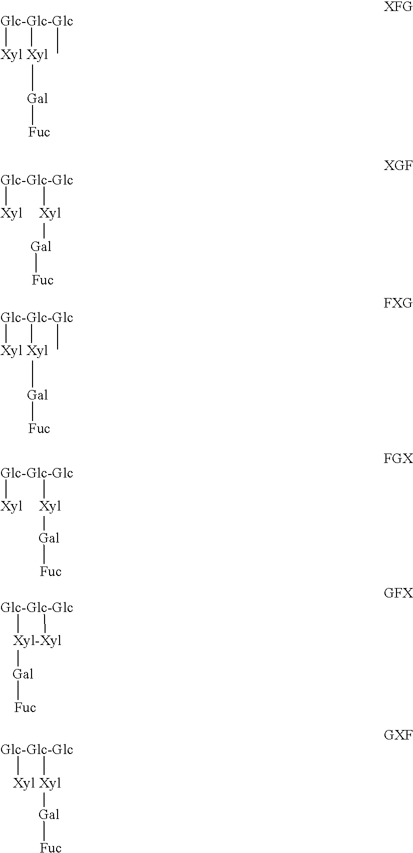

the glucose residue in the terminal position of said compounds being reduced or not, or comprising structures derived by modification as defined above.

In a particularly advantageous embodiment of the invention, compound A corresponds to the following formula (I):

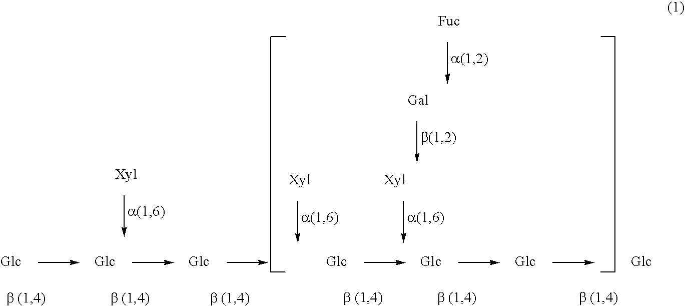

In a particularly advantageous embodiment of the invention, compound A corresponds to the following formula XFG:

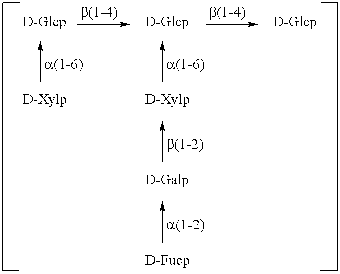

or to the following formula XFGol:

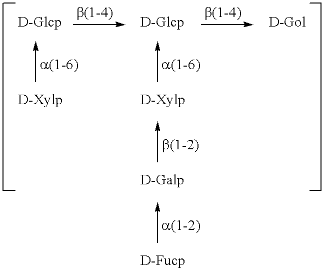

The process according to the invention may be utilised for the treatment of any plant, in particular agronomically useful plants, such as the vine, fruit trees (in particular kiwi, walnut, apricot, apple, shadbush, cherry tree, plum-tree, pear, coffee-tree), grasses such as turf, cereals (in particular rice, barley), oleaginous plants (in particular soya, rape, sunflower), protein plants (in particular peas), and market garden crops (in particular tomatoes).

The spraying may be realized at any time between the winter bud stage and the 14 spread leaves stage, advantageously between the budbreak stage and the 6 spread leaves.

It may also be realised at any time between budbreak stage and the stage where flower buds are visible. These stages are well known from the one skilled in the art and defined according to classically used scales, in particular the BBCH scale (Biologische Bundeanstalt, Bundessorteamt und Chemsiche Industrie

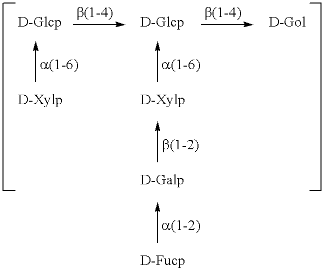

The process according to the invention may be utilised for the treatment of any plant, in particular agronomically useful plants, such as the vine, fruit trees (in particular kiwi, walnut, apricot, apple, shadbush, cherry tree, plum-tree, pear, coffee-tree), grasses such as turf, cereals (in particular rice, barley), oleaginous plants (in particular soya, rape, sunflower), protein plants (in particular peas), and market garden crops (in particular tomatoes).

The spraying may be realized at any time between the winter bud stage and the 14 spread leaves stage, advantageously between the budbreak stage and the 6 spread leaves.

It may also be realised at any time between winter bud stage and first flower, advantageously at any time between budbreak stage and the stage where flower buds are visible. These stages are well known from the one skilled in the art and defined according to classically used scales, in particular the BBCH scale (Biologische Bundeanstalt, Bundessorteamt und Chemsiche Industrie Stades phénologiques des mono-et dicotylédones cultivées BBCH Monographie2, Edition 2001).

According to the invention, the process may comprise between one and hundred foliar sprayings during the abiotic stress that is to say during a drought period or during the period of spring frost.

The compositions used according to the invention are prepared by techniques known from the one skilled in the art and may comprise water, organic solvents, alcohols and esters, surface active agents, fungicides and any other compounds classically used in the composition of factor of production for agriculture.

In an advantageous embodiment of the invention, the composition which is used may comprise in particular one polyol chosen from the group comprising sorbitol, mannitol, xylitol, ethylene glycol, glycerol or glycerine, polyethylene oxide or polyethylene glycol, polypropylene glycol and polytetramethylene glycol, said polyol representing between 0.01 and 1% of the composition, advantageously between 0.05 and 0.5%, even more advantageously between 0.08 and 0.15% and the xyloglucan derivative is present in a concentration comprised between 0.1 nM and H1M, advantageously in a concentration comprised between 1 and 500 nM

With the process according to the invention, a decrease of up to 50% of the damages to the leaves is observed when the temperature is comprised between +2 and -7° C., advantageously between −2 and +5° C. with a relative humidity of 60 to 100%.

The resistance to cold due to the process according to the invention lasts in general between 4 and 7 days but may still be observed 14 days after the application.

The following example illustrates the invention.

### EXAMPLE 1

### Improvement of the Frost-Resistance of Vine Plants

1.1. Operating Method

Plants originating from different vine varieties: the Chardonnay, Pinot noir and Cabernet-Sauvignon varieties are used. Each sample, composed of 5 to 21 plants, is treated by foliar spraying at different vegetative stages on the BBCH scale with a mixture containing the xyloglucan elicitor, HEPTAMALOXYLOGLUCAN or XFGol in solution at variable doses; the spraying of 2.5 ml of solution per plant is carried out using a sprayer (deviation of +/−1%).

12 hours after the application of the elicitor, the plants were exposed to cold stress at −3 to −5° C. After exposure to the cold, the plants are placed in a climatic chamber at 20° C. with a 12-hour day/night alternation. The appearance of the leaves is observed 24 hours and 72 hours after removal from the cold. The effects of the cold are evaluated by observing the foliar necroses induced by frost and the plants are kept for several months in order to monitor their subsequent development.

1.2. Results

The results are expressed by the protection index IP: IP (%)=100−P; P, being the proportion of necrotized leaves.

The results are also expressed in gain:

$$Gain = \frac{( IP Elicited - IP Control )}{IP Control} expressed in \%$$

Pinot Noir

| | | Elicitor | Elicitor | Elicitor | Elicitor | Elicitor |
|---|---|---|---|---|---|---|
| | Control | 5 nM | 50 nM | 500 nM | 0.5 nM | 5000 nM |
| Number of | 95 | 92 | 33 | 69 | 15 | 15 |
| plants | | | | | | |

| | | | | | |
|---|---|---|---|---|---|
| Gain | 34% | 0% | 27% | 0% | 25% |

For pinot noir, at a range of 0.5 nM to 5000 nM, the spray mixture containing 5 nM of heptamaloxyloglucane as elicitor induces a protection against frost more efficient than the other doses.

Chardonnay

| | Control | Elicitor | Elicitor | Elicitor | Elicitor | Elicitor |
|---|---|---|---|---|---|---|
| | | 5 nM | 50 nM | 500 nM | 0.5 nM | 5000 nM |
| Number of | 80 | 72 | 38 | 45 | 11 | 11 |
| plants | | | | | | |

| | | | | | |
|---|---|---|---|---|---|
| Gain | 42% | 9% | 0% | 28% | 28% |

For chardonnay, at a range of 0.5 nM to 5000 nM, the spray mixture containing 5 nM of heptamaloxyloglucane as elicitor induces a protection against frost more efficient than the other doses.

Cabernet Sauvignon

| | Control | Elicitor 5 nM | Elicitor 50 nM | Elicitor 500 nM |
|---|---|---|---|---|
| Number of | 29 | 29 | 29 | 24 |
| plants | | | | |

| | | | |
|---|---|---|---|
| Gain | 46% | 35% | 76% |

For cabernet sauvignon, the spray mixture containing 500 nM of heptamaloxyloglucane as elicitor induces a protection against frost more efficient than the other doses.

Results show that according to the varieties the posology of the elicitor should be comprised in a range of 5 nM-500 nM.

### EXAMPLE 2

### Improvement of the Frost-Resistance of Kiwis Plants

The elicitor which is used is HEPTAMALOXYLOGLUCAN (or XFGol).

Before the cold stress, plants are treated or not by foliar spraying with a spray mixture containing HEPTAMALOXYLOGLUCAN.

After application of the spraying mixture, the plants were exposed to cold stress. In order to reproduce artificial conditions of cold stress, plants were placed in a climatic chamber.

The effects of cold are evaluated by observing the death of buds due to frost.

The results are expressed by the protection index IP: IP (%)=100-P; P, being the proportion of dead buds.

The results are also expressed in gain:

$$Gain = \frac{( IP Elicited - IP Control )}{IP Control} expressed in \%$$

The results are given in the following table:

Increase of protection of kiwi plants elicited by the product PEL101GV (500 nM). IP corresponds to the protection index of kiwi buds, 28 days after the cold stress at −2,8° C. or −4° C. (IP=100−P; P=proportion of dead buds)

| | |
|---|---|
| −2.8° C. | −4° C. |

| | | Elicitor | | Elicitor |
|---|---|---|---|---|
| | Control | 500 nM | Control | 500 nM |
| IP | 64 | 81 | 30 | 56 |
| Gain % | — | 27 | — | 87 |

The results show that the heptamaloxyloglucan leads to a better protection of the kiwi buds against frost.

1. A process for adapting plants to an abiotic stress, in particular to cold or to a hydric stress, in particular drought, humidity or salinity, wherein said process comprises at least a step of treatment of the plants by foliar field spraying with a composition comprising at least one xyloglucan derivative at a concentration of 0.01 mg to 2 g/ha of said xyloglucan derivative, advantageously from 0.1 mg to 0.5 g/ha, said spraying step being realized between 1 and 72 hours before the stress arrived, advantageously between 5 and 48 hours before said stress.

2. Process according to claim 1 wherein the at least one xyloglucan derivative corresponds to the formula:
[X1-X2-X3-(X4)n]N
in which
X1, X2, X3, and X4, independently of each other, represent a monosaccharide chosen from glucose, galactose, xylose, fucose and arabinose, this monosaccharide being if appropriate in reduced form and/or being substituted, in particular by a C₁-C₄ alkyl or acyl group, such as a methyl or acetyl group, X1, X2, X3, and X4, independently of each other, being if appropriate substituted by one or more monosaccharides chosen from glucose, galactose, xylose, fucose and arabinose, and/or by one or more monosaccharide chain formations of formula X5−X6−(X7)m, in which X5, X6, and X7, independently of each other, represent a monosaccharide chosen from glucose, galactose, xylose, fucose and arabinose, and m represents 0 or 1, or a compound derived from those defined above, in particular by modification or substitution of one or more abovementioned monosaccharides,
n represents 0 or 1 and
N represents an integer comprised between approximately 50 and approximately 300, advantageously comprised between approximately 50 and approximately 100, in the case of polymers and represents an integer comprised between approximately 1 and approximately 50, advantageously comprised between approximately 2 and approximately 50, even more advantageously comprised between approximately 2 and approximately 20, in particular between 5 and 12, in the case of oligomers.

3. Process according to claim 1, wherein the at least one xyloglucan polymer is a compound A which comprises:
one or two X chain formations, X being chosen from the group constituted by the following chain formations:
α-D-Xylopyranosyl(1,6)-β-D-Glucopyranosyl,
α-D-Xylopyranosyl(1,6)-D-Glucopyranose,
β-D-Xylopyranosyl(1,4)-β-D-Glucopyranosyl and
β-D-Xylopyranosyl (1,4)-D-Glucopyranose, or a reduced form of X, also denoted Xol,
one or two F chain formations, F being chosen from the group constituted by the following chain formations:
α-L-Fucopyranosyl(1,2)-β-D-Galactopyranosyl,
(1,2)-α-D-Xylopyranosyl(1,6)-β-D-Glucopyranosyl,
α-L-Fucopyranosyl(1,2)-β-D-Galactopyranosyl,
(1,2)-α-D-Xylopyranosyl(1,6)-D-Glucopyranose,
α-L-Fucopyranosyl(1,2)-β-D-Galactopyranosyl(1,2)-β-D-Xylopyranosyl(1,4)-β-D-Glucopyranosyl and
α-L-Fucopyranosyl(1,2)-β-D-(1,2)-β-D-Xylopyranosyl(1,4)-D-Glucopyranose, or a reduced form of F, also denoted Fol, and
at least one G chain formation, G being chosen from the group constituted by the following units:
β-D-glucopyranosyl and
D-Glucopyranose,
said units being optionally substituted in position 4, or a reduced form of G, also denoted Gol,
said X, F and G chain formations being linked to each other in a random order, and comprising, if appropriate, the following modifications: (i) by modification of hydroxyl groups, namely acetylated or methoxylated or acylated derivatives, the glucose residue in the terminal position of which is reduced or not, (ii) by modification of the reducing terminal unit, such as by reductive amination, (iii) by oxidation, in position 6 of the accessible Gal and Glc residues.

4. Process according to claim 1, wherein the compounds A are chosen from the group comprising the following formulae:
(X)ₐ(F)_{b}(G)_{c}
(X)ₐ(G)_{c}(F)_{b}
(F)_{b}(X)ₐ(G)_{c}
(F)_{b}(G)_{c}(X)ₐ
(G)_{c}(X)ₐ(F)_{b}
(G)_{c}(X)ₐ(F)_{b}
in which:
G, X and F are as defined previously and a, b, and c, independently of each other represent 1, or 2.

5. Process for adapting plants to an abiotic stress, in particular to cold or to a hydric stress, in particular drought, humidity or salinity, wherein said process comprises at least a step of treatment of the plants by foliar field spraying with a composition comprising at least one xyloglucan derivative at a concentration of 0.01 mg to 2 g/ha of said xyloglucan derivative, advantageously from 0.1 mg to 0.5 g/ha, said spraying step being realized between 1 and 72 hours before the stress arrived, advantageously between 5 and 48 hours before said stress,
wherein the compound A is chosen from the group comprising XFG, FXG, FGX, GFX, and GXF, the glucose residue in the terminal position of which is reduced or not, or comprising structures derived by modification as defined in claim 2.

6. Process according to claim 1, wherein the compound A is selected from the group comprising: XGXG, XFGX, FGXX, FXGX, FXXG, GXXF, GXFX, GFXX, XXGF, XGXF, XGFX and XXFG.

7. Process according to claim 1, wherein the compound A corresponds to the following formula (I):

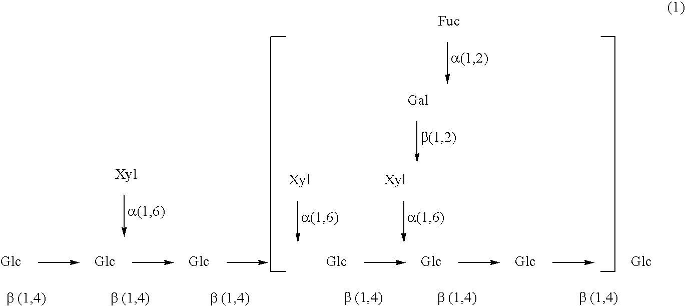

8. Process according to claim 1, wherein the compound A corresponds to the following formula XFG: 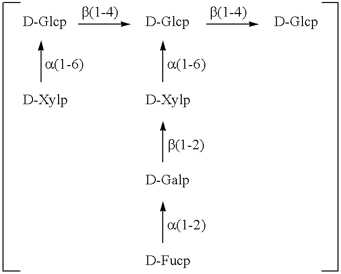
or to the following formula XFGol:

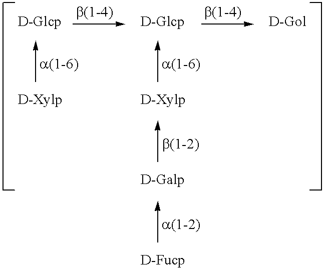

9. Process according to claim 1, wherein plants are selected from the group comprising the vine, fruit trees, grasses, cereals, oleaginous plants, protein plants and market garden crops.

10. Process according to claim 9 wherein the fruit trees are selected from the group comprising kiwi, walnut, apricot, apple, shadbush, cherry tree, plum-tree, pear and coffee-tree.

11. Process according to claim 1, wherein the foliar field spraying is realized at any time between the winter bud stage and the 14 spread leaves stage, advantageously between the budbreak stage and the 6 spread leaves.

12. Process according to claim 1, wherein the foliar field spraying is realised at any time between winter bud stage and first flower, advantageously at any time between budbreak stage and the stage where flower buds are visible.

13. Process according to claim 1, wherein between one and hundred foliar sprayings are realised during the abiotic stress.

14. Process according to claim 13 wherein the abiotic stress is a drought period or a period of spring frost.

15. Process according to claim 2, wherein the at least one xyloglucan polymer is a compound A which comprises:
one or two X chain formations, X being chosen from the group constituted by the following chain formations:
α-D-Xylopyranosyl(1,6)-β-D-Glucopyranosyl,
α-D-Xylopyranosyl(1,6)-D-Glucopyranose,
β-D-Xylopyranosyl(1,4)-β-D-Glucopyranosyl and
β-D-Xylopyranosyl (1,4)-D-Glucopyranose, or a reduced form of X, also denoted Xol,
one or two F chain formations, F being chosen from the group constituted by the following chain formations:
α-L-Fucopyranosyl(1,2)-β-D-Galactopyranosyl,
(1,2)-α-D-Xylopyranosyl(1,6)-β-D-Glucopyranosyl,
α-L-Fucopyranosyl(1,2)-β-D-Galactopyranosyl,
(1,2)-α-D-Xylopyranosyl(1,6)-D-Glucopyranose,
α-L-Fucopyranosyl(1,2)-β-D-Galactopyranosyl(1,2)-β-D-Xylopyranosyl(1,4)-β-D-Glucopyranosyl and
α-L-Fucopyranosyl(1,2)-β-D-(1,2)-β-D-Xylopyranosyl(1,4)-D-Glucopyranose, or a reduced form of F, also denoted Fol, and
at least one G chain formation, G being chosen from the group constituted by the following units:
β-D-glucopyranosyl and
D-Glucopyranose,
said units being optionally substituted in position 4, or a reduced form of G, also denoted Gol,
said X, F and G chain formations being linked to each other in a random order, and comprising, if appropriate, the following modifications: (i) by modification of hydroxyl groups, namely acetylated or methoxylated or acylated derivatives, the glucose residue in the terminal position of which is reduced or not, (ii) by modification of the reducing terminal unit, such as by reductive amination, (iii) by oxidation, in position 6 of the accessible Gal and Glc residues.

16. Process according to claim 2, wherein the compounds A are chosen from the group comprising the following formulae:
(X)ₐ(F)_{b}(G)_{c}
(X)ₐ(G)_{c}(F)_{b}
(F)_{b}(X)ₐ(G)_{c}
(F)_{b}(G)_{c}(X)ₐ
(G)_{c}(X)ₐ(F)_{b}
(G)_{c}(X)ₐ(F)_{b}
in which:
G, X and F are as defined previously and a, b, and c, independently of each other represent 1, or 2.

17. Process according to claim 3, wherein the compounds A are chosen from the group comprising the following formulae:
(X)ₐ(F)_{b}(G)_{c}
(X)ₐ(G)_{c}(F)_{b}
(F)_{b}(X)ₐ(G)_{c}
(F)_{b}(G)_{c}(X)ₐ
(G)_{c}(X)ₐ(F)_{b}
(G)_{c}(X)ₐ(F)_{b}
in which:
G, X and F are as defined previously and a, b, and c, independently of each other represent 1, or 2.

18. Process according to claim 2, wherein the compound A is selected from the group comprising: XGXG, XFGX, FGXX, FXGX, FXXG, GXXF, GXFX, GFXX, XXGF, XGXF, XGFX and XXFG.

19. Process according to claim 3, wherein the compound A is selected from the group comprising: XGXG, XFGX, FGXX, FXGX, FXXG, GXXF, GXFX, GFXX, XXGF, XGXF, XGFX and XXFG.

20. Process according to claim 4, wherein the compound A is selected from the group comprising: XGXG, XFGX, FGXX, FXGX, FXXG, GXXF, GXFX, GFXX, XXGF, XGXF, XGFX and XXFG.
